(19) United States
(12) Patent Application Publication
(10) Pub. No.: US 2003/0057717 A1
(43) Pub. Date: Mar. 27, 2003

(54) Sash lock for a sash window

(76) Inventors: Mark V. Murphy, Oak Park, IL (US); Dean Pettit, St. John, IN (US)

Correspondence Address: Thomas K. Stine, Esq., Wallenstein & Wagner, Ltd., 53rd Floor, 311 South Wacker Drive, Chicago, IL, 60606-6630, US

(21) Appl. No.: 09/961,501

(22) Filed: Sep. 24, 2001

(51) Int. Cl. E05C 3/04

(52) U.S. Cl. 292/241

(57) ABSTRACT

A sash lock for a sash window assembly is disclosed. The sash window assembly includes an upper sash window and a lower sash window. Each of the sash windows is mounted within opposed guide rails on a master frame. At least one of the sash windows is slidable within the frame relative to the other sash window. The sash lock comprises a keeper for mounting on a style of one of the sash windows. The keeper includes a keeper surface. The sash lock also includes a locking assembly for mounting on an adjacent style of the other of the sash windows. The locking assembly includes a housing having a hole, an actuator arm, and a cam having a cam surface for engaging the keeper surface. The locking assembly also includes a shaft extending through the housing hole and operably coupling the actuator arm to the cam. The keeper, the housing, the actuator arm and the shaft are formed of plastic and the cam is formed of metal.

### CROSS-REFERENCE TO RELATED APPLICATIONS

Not Applicable.

### FEDERALLY SPONSORED RESEARCH OR DEVELOPMENT

Not Applicable.

### TECHNICAL FIELD

The present invention relates to a sash lock for a sash window.

### BACKGROUND OF THE INVENTION

Prior art to this invention includes U.S. Pat. Nos. 5,582,445; 5,741,032; 6,116,665; 6,142,541; and Re. No. 35,463. However, none of these patents discloses a sash lock having a cam formed of a metal, such as zinc, and all other components formed of a plastic.

The present invention is provided to solve these and other problems.

### SUMMARY OF THE INVENTION

It is an object of the invention to provide a sash lock for a sash window assembly.

In accordance with the invention, the sash window assembly includes an upper sash window and a lower sash window. Each of the sash windows is mounted within opposed guide rails on a master frame. At least one of the sash windows is slidable within the frame relative to the other sash window.

The sash lock comprises a keeper for mounting on a style of one of the sash windows. The keeper includes a keeper surface. The sash lock also includes a locking assembly for mounting on an adjacent style of the other of the sash windows. The locking assembly includes a housing having a hole, an actuator arm, and a cam having a cam surface for engaging the keeper surface. The locking assembly also includes a shaft extending through the housing hole and operably coupling the actuator arm to the cam. The keeper, the housing, the actuator arm and the shaft are formed of plastic and the cam is formed of metal.

It is contemplated that the plastic is glass filled polypropylene, glass filled nylon, a blend of glass filled polypropylene and nylon, or glass filled acetone.

It is further contemplated that the metal is zinc.

### BRIEF DESCRIPTION OF THE DRAWINGS

FIG. 1 is a perspective view of a sash window assembly;

FIGS. 2a, 2b, and 2c are a top view of the sash lock of the present invention, and respective sectional views, thereof;

FIGS. 3a, 3b, 3c, and 3d are a perspective view, and top, side and bottom views, of a keeper of the sash lock of FIG. 1;

FIGS. 4a, 4b and 4c are respective perspective views and sectional view of a housing of the sash lock of FIG. 1, FIG. 4d is a detail of FIG. 4c;

FIG. 4c is a detail of a hole in the housing of FIGS. 4a and b;

FIGS. 5a, 5b, and 5c are respective top, side and bottom views of an actuator arm of the sash lock of FIG. 1; and

FIGS. 6a, 6b, 6c and 6d are respective perspective, top, bottom and sectional views of a cam of the sash lock of FIG. 1.

### DETAILED DESCRIPTION OF THE INVENTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

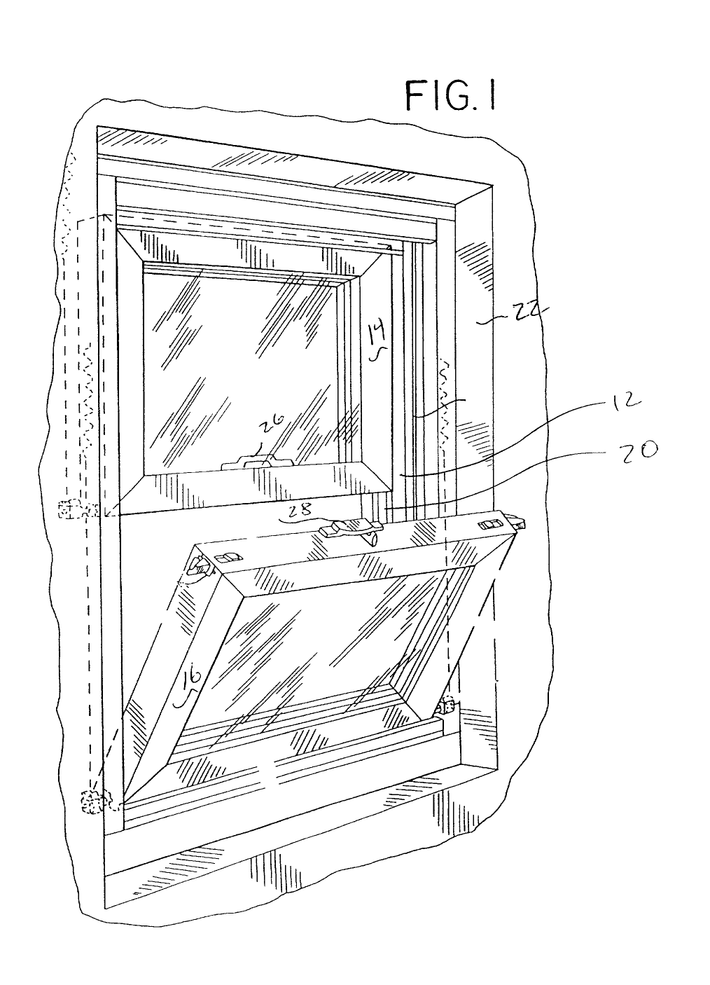

A sash lock 10 for a sash window assembly 12 is illustrated in the Figures. Referring in particular to FIG. 1, the sash window assembly 12 includes an upper sash window 14 and a lower sash window 16. Each of the sash windows 14, 16 is mounted within opposed guide rails 20 on a master frame 22. At least one of the sash windows 14, 16 is slidable within the frame 22 relative to the other of the sash windows 14, 16.

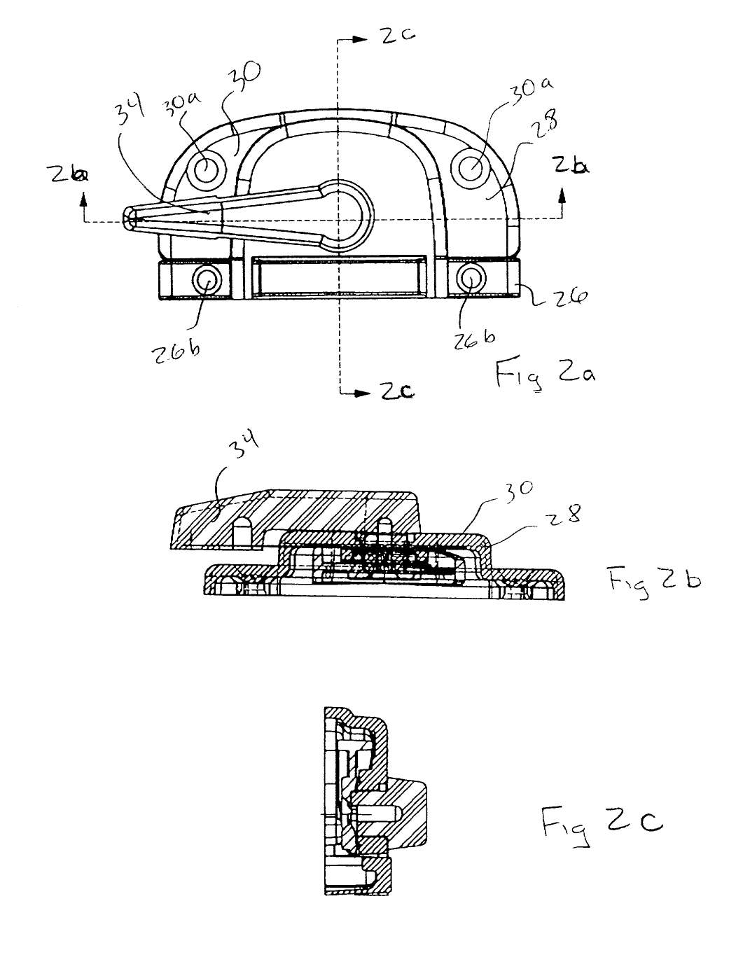

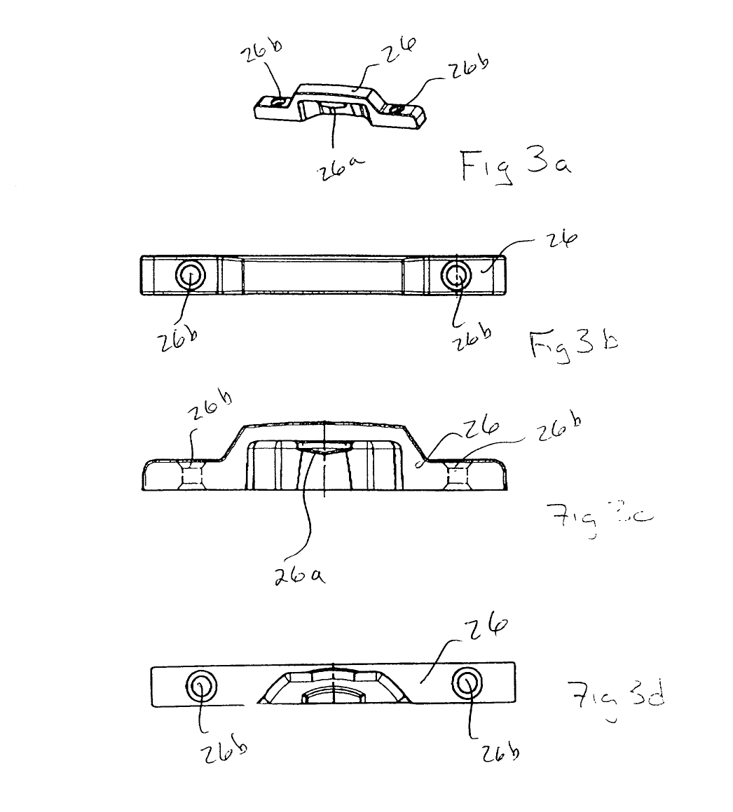

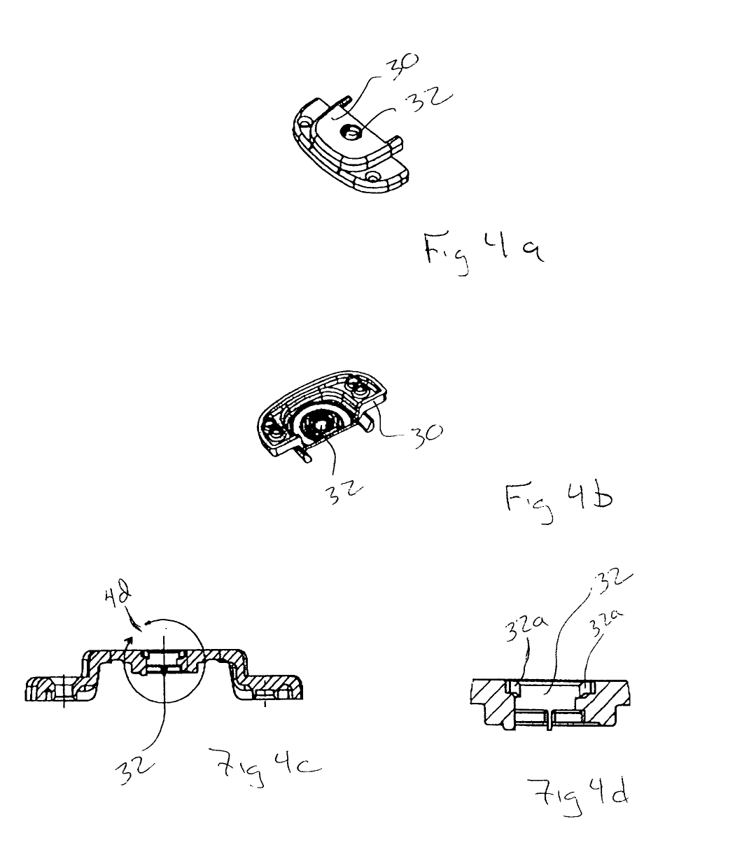

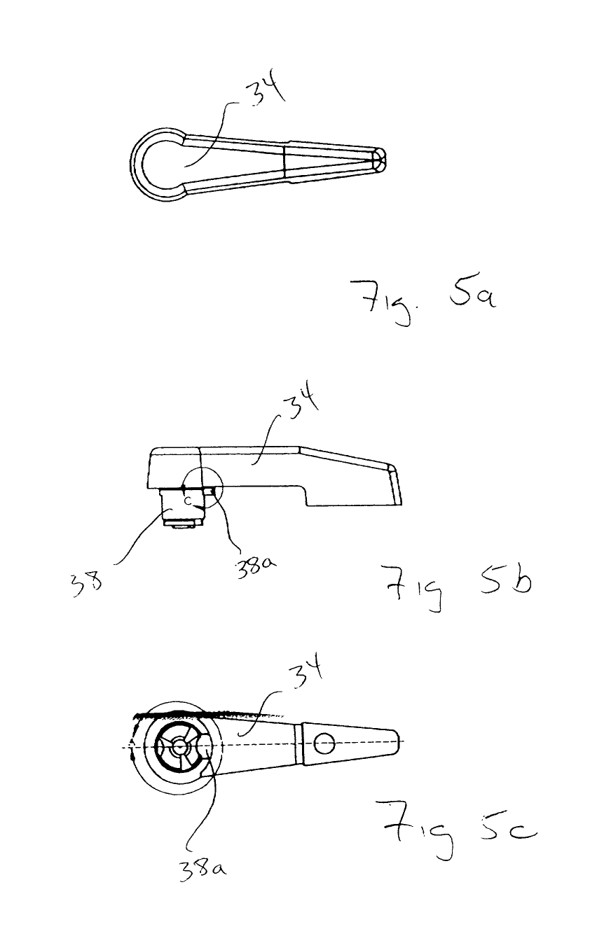

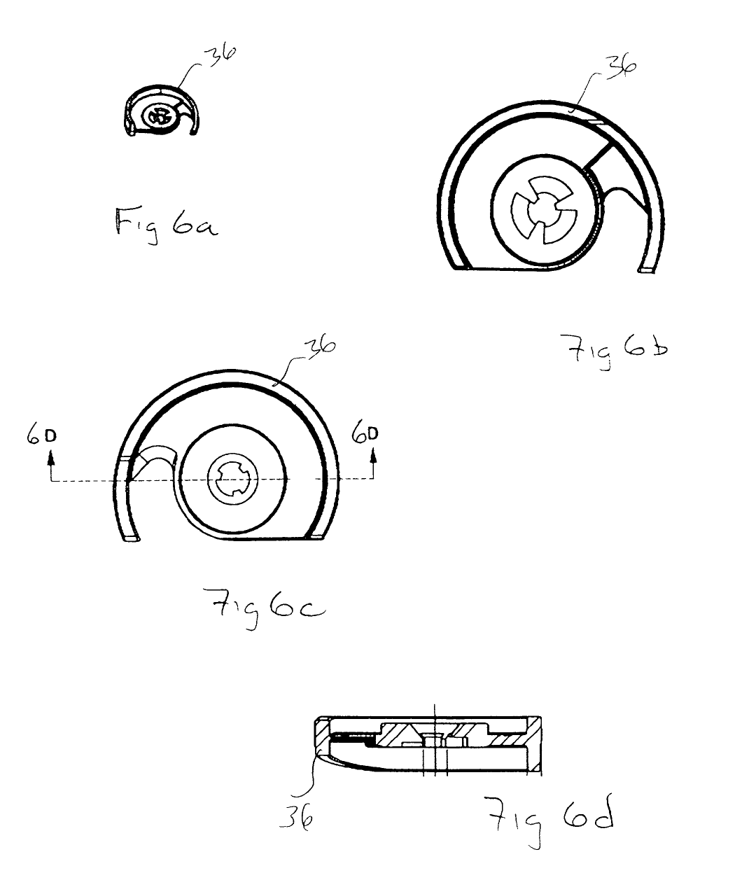

Referring now to FIGS. 2-6, the sash lock 10 comprises a keeper 26 for mounting on a style of one of the upper sash windows 14. The keeper 26 includes a keeper surface 26a. The sash lock 10 also includes a locking assembly 28 for mounting on an adjacent style of the lower sash window 16. The locking assembly 28 includes a housing 30 having a hole 32, an actuator arm 34, and a cam 36 having a cam surface 36a for engaging the keeper surface 26a. The locking assembly 28 also includes a shaft 38 extending through the housing hole 32 and operably coupling the actuator arm 34 to the cam 36.

The keeper 26, the housing 30, the actuator arm 34 and the shaft 38 are formed of plastic. The plastic is preferably glass filled polypropylene, glass filled nylon, a blend of glass filled polypropylene and nylon, or glass filled acetone. The cam 36 is formed of metal, preferably zinc.

The actuator arm 34 and the shaft 38 are a unitary piece. The shaft 38 and the cam 36 have cooperatively mating faces for rotatably securing the shaft 38 to the cam 36. The shaft 38 and the hole 32 have corresponding circumferential surfaces. The shaft has a shaft projection 38a extending from its circumferential surface. The hole 32 has two spaced hole projections 32a extending from its circumferential surface. The shaft projection 38a engages one or the other of the hole projections 32a to limit rotational travel of the actuator arm 34 and thereby define unlocked and locked positions, respectively.

A shaft has a threaded screw receiving hole 38b to receive a metal screw (not shown) to secure the cam 36 to the shaft 38.

The housing 30 has a pair of holes for receiving screws (not shown) to secure the housing 30 to its style. The keeper 26 has a pair of keeper holes 26a for receiving screws (not shown) to secure the keeper 26 to its style.

While the specific embodiments have been illustrated and described, numerous modifications come to mind without significantly departing from the spirit of the invention and the scope of protection is only limited by the scope of the accompanying claims.

We claim:

1. A sash lock for a sash window assembly, the sash window assembly including an upper sash window and a lower sash window, each of the sash windows mounted within opposed guide rails on a master frame, wherein at least one of the sash windows is slidable within the frame relative to the other sash window, the sash lock comprising:
a keeper for mounting on a style of one of the sash windows, the keeper including a keeper surface; and
a locking assembly for mounting on an adjacent style of the other of the sash windows, the locking assembly including:
a housing having a hole;
an actuator arm;
a cam having a cam surface for engaging the keeper surface; and
a shaft extending through the housing hole and operably coupling the actuator arm to the cam, wherein the keeper, the housing, the actuator arm and the shaft are formed of plastic and the cam is formed of metal.

2. The sash lock of claim 1, wherein the plastic is glass filled polypropylene.

3. The sash lock of claim 1, wherein the plastic is glass filled blend of polypropylene and nylon.

4. The sash lock of claim 1, wherein the plastic is glass filled nylon.

5. The sash lock of claim 1, wherein the plastic is glass filled acetone.

6. The sash lock of claim 1, wherein the metal is zinc.

7. The sash lock of claim 1, wherein the actuator arm and the shaft are a unitary piece.

8. The sash lock of claim 1, wherein each of the shaft and the cam have cooperatively mating faces for securing the shaft to the cam.

9. The sash lock of claim 1 wherein:
the shaft and the hole have corresponding circumferential surfaces;
the shaft has a shaft projection extending from its circumferential surface; and
the hole has spaced hole projections extending from its circumferential surface, and the shaft projection engages one or the other of the hole projections to define an unlocked or locked position, respectively.

10. The sash lock of claim 1 including a metal screw for securing the cam to the shaft.

11. The sash lock of claim 1, wherein the housing has a pair of holes for receiving screws to secure the housing to its style.

12. The sash lock of claim 1, wherein the keeper has a pair of holes for receiving screws to secure the keeper to its style.
